(19) United States
(12) Patent Application Publication
(10) Pub. No.: US 2026/0058082 A1
(43) Pub. Date: Feb. 26, 2026

(54) SHUTDOWN DEVICE AND SHUTDOWN SYSTEM

(71) Applicant: Panasonic Intellectual Property Management Co., Ltd., Osaka (JP)

(72) Inventors: HIDEKI IWAKI, Osaka (JP); TOMOAKI FURUSE, Osaka (JP); EIICHI SADAYUKI, Osaka (JP)

(21) Appl. No.: 18/853,716

(22) PCT Filed: Apr. 13, 2023
(86) PCT No.: PCT/JP2023/014985

§ 371 Date: Jun. 23, 2025

(30) Foreign Application Priority Data
Apr. 22, 2022 (JP) 2022-070622

(51) Int. Cl. H01H 85/10; H01H 37/76; H01H 39/00; H01H 85/18

(52) U.S. Cl. CPC H01H 85/10; H01H 37/76; H01H 39/00; H01H 85/18

(57) ABSTRACT

A shutdown device includes: a pyro-fuse that includes a bus bar inserted into a power supply path and a piston disposed above the bus bar, the piston moving toward the bus bar to divide the bus bar; and a melting fuse connected in parallel to the pyro-fuse, in which the melting fuse includes a fuse case, a fuse element provided in the fuse case and is fused when an overcurrent flows, and an arc-extinguishing material provided in the fuse case and being in a granular phase, and the fuse element extends along a direction intersecting a direction in which the piston moves.

### TECHNICAL FIELD

The present disclosure relates to a shutdown device that shuts down a power supply path, and a shutdown system including the shutdown device.

### BACKGROUND ART

In related art, there is known a shutdown device that protects an electric circuit by shutting down a power supply path in a case where an overcurrent flows through the power supply path of the electric circuit. As an example of this type of shutdown device, PTL 1 discloses a shutdown device including a pyro-fuse disposed on a power supply path and a melting fuse connected in parallel to the pyro-fuse. In this shutdown device, when the power supply path is shut down by the pyro-fuse, a current that continues to flow to a pyro-fuse side flows to a melting fuse side, and thus, generation of an arc (arc discharge) in the pyro-fuse is suppressed.

### CITATION LIST

### Patent Literature

PTL 1: Unexamined Japanese Patent Publication No. 2021-170522

### SUMMARY OF THE INVENTION

However, in the shutdown device disclosed in PTL 1, there is a problem that the arc is generated when the melting fuse is fused by the current flowing to the melting fuse side and the electric circuit cannot be sufficiently protected.

Therefore, the present disclosure provides a shutdown device capable of efficiently extinguishing an arc generated in a melting fuse, and a shutdown system including the shutdown device.

A shutdown device according to an aspect of the present disclosure includes: a pyro-fuse that includes a bus bar inserted into a power supply path and a piston disposed above the bus bar, the piston moving toward the bus bar to divide the bus bar; and a melting fuse connected in parallel to the pyro-fuse, in which the melting fuse includes a fuse case, a fuse element provided in the fuse case and is fused when an overcurrent flows, and an arc-extinguishing material provided in the fuse case and being in a granular phase, and the fuse element extends along a direction intersecting a direction in which the piston moves.

A shutdown system according to another aspect of the present disclosure includes: the shutdown device; and an abnormality detection device that outputs a shutdown signal to the pyro-fuse in a case where an abnormality occurs in the power supply path, in which the pyro-fuse of the shutdown device is ignited based on the shutdown signal output from the abnormality detection device to move the piston toward the bus bar, and divides the bus bar.

According to the shutdown device and the shutdown system of the present disclosure, the arc generated in the melting fuse can be efficiently extinguished.

### BRIEF DESCRIPTION OF THE DRAWINGS

FIG. 1 is a diagram illustrating a schematic circuit configuration of a shutdown system according to an exemplary embodiment.

FIG. 2 is a perspective view of a shutdown device according to the exemplary embodiment.

FIG. 3 is a diagram of the shutdown device according to the exemplary embodiment as viewed from above.

FIG. 4 is a sectional view illustrating a pyro-fuse included in the shutdown device according to the exemplary embodiment.

FIG. 5 is a perspective view of the melting fuse included in the shutdown device according to the exemplary embodiment.

FIG. 6 is a sectional view of the melting fuse included in the shutdown device according to the exemplary embodiment.

FIG. 7 is a diagram illustrating states before and after fusion of the melting fuse included in the shutdown device according to the exemplary embodiment.

FIG. 8 is a perspective view of a shutdown device according to a modified example of the exemplary embodiment.

FIG. 9 is a schematic view of the shutdown device according to the modified example of the exemplary embodiment as viewed from above.

### DESCRIPTION OF EMBODIMENT

Hereinafter, an exemplary embodiment will be specifically described with reference to the drawings.

Note that, the exemplary embodiment to be described below is intended to provide comprehensive or specific examples. Numerical values, shapes, components, disposed positions and connection forms of the components, and the like to be presented in the following exemplary embodiment are illustrative and are not to limit the present disclosure. In addition, among the components in the following exemplary embodiment, components not recited in the independent claims are described as any components.

In addition, all the drawings are schematic views, and are not necessarily illustrated precisely. As a result, for example, scales and the like do not necessarily coincide in the drawings. In addition, in each drawing, substantially identical components are denoted by identical reference marks, and the redundant description will be omitted or simplified.

In addition, in the present specification, terms indicating relationships between elements, such as orthogonal, parallel, perpendicular, and same, and terms indicating a shape of an element, such as rectangular shape and circular shape, numerical values, and numerical ranges are not expressions representing only strict meanings, but are expressions meaning to include a substantially equivalent range, for example, a difference of about several % (for example, about 10%).

In addition, in the present specification, the description may be given by using terms indicating directions such as “up”, “down”, “left”, “right”, “front”, and “rear”. However, these terms merely indicate a relative positional relationship, and the present disclosure is not limited thereto.

### Exemplary Embodiment

### Configuration of Shutdown System

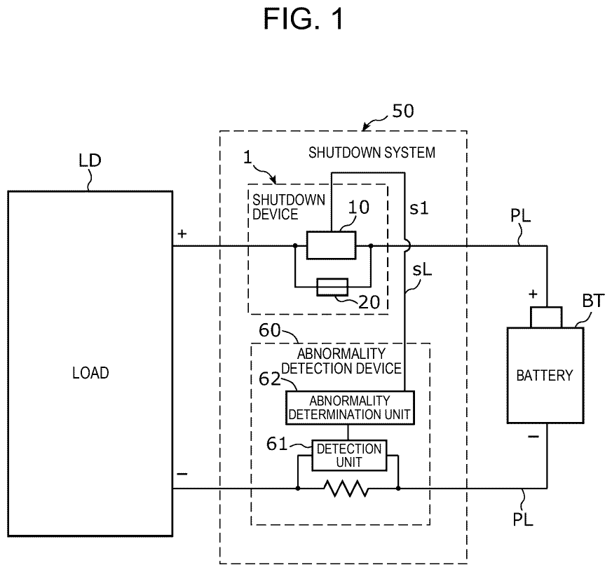

A shutdown system according to an exemplary embodiment will be described with reference to FIG. 1.

FIG. 1 is a diagram illustrating a schematic circuit configuration of shutdown system 50 according to the exemplary embodiment.

Shutdown system 50 is provided in power supply path PL for supplying power from battery BT to load LD. Shutdown system 50 is a system that shuts down the supply of the power in a case where an abnormality occurs in power supply path PL. Shutdown system 50 includes abnormality detection device 60 and shutdown device 1. Shutdown device 1 is connected to abnormality detection device 60 via signal line sL.

As illustrated in FIG. 1, abnormality detection device 60 is provided in power supply path PL connecting a negative electrode of battery BT and a negative electrode side of load LD. Shutdown device 1 is provided in power supply path PL connecting a positive electrode of battery BT and a positive electrode side of load LD. Note that, abnormality detection device 60 may be provided in power supply path PL connecting the positive electrode of battery BT and the positive electrode side of load LD, and shutdown device 1 may be provided in power supply path PL connecting the negative electrode of battery BT and the negative electrode side of load LD. That is, abnormality detection device 60 and shutdown device 1 may be connected to different poles of battery BT. In addition, abnormality detection device 60 and shutdown device 1 may be connected in series to the same pole of battery BT.

Battery BT is, for example, a secondary battery such as a lithium ion battery. Load LD is, for example, an electric device such as a motor, an inverter circuit, or a DC-DC converter. Battery BT supplies a direct current to load LD via power supply path PL, or receives a direct current from load LD.

Abnormality detection device 60 is a device that detects an abnormality in power supply path PL. Abnormality detection device 60 includes detection unit 61 for detecting an abnormality in power supply path PL and abnormality determination unit 62 for determining whether or not the abnormality occurs in power supply path PL.

Detection unit 61 detects an abnormal state of power supply path PL by detecting a current flowing through power supply path PL. For example, detection unit 61 detects the current in power supply path PL by measuring a voltage at both ends of a resistor inserted in power supply path PL. A detection value detected by detection unit 61 is output to abnormality determination unit 62.

Abnormality determination unit 62 determines whether or not the abnormality occurs in power supply path PL based on the detection value output from detection unit 61. For example, abnormality determination unit 62 determines that the abnormality occurs in power supply path PL in a case where a current value output from detection unit 61 exceeds a predetermined threshold value. In a case where it is determined that the abnormality occurs in power supply path PL, abnormality determination unit 62 outputs shutdown signal s1 for shutting down power supply path PL to shutdown device 1 via signal line sL.

Note that, in a case where abnormality detection device 60 is connected to communicate with, for example, an electronic control unit (ECU) of an automobile, abnormality detection device 60 may output shutdown signal s1 to shutdown device 1 based on a crash signal output from the ECU. Hereinafter, a configuration of shutdown device 1 will be described.

### Configuration of Shutdown Device

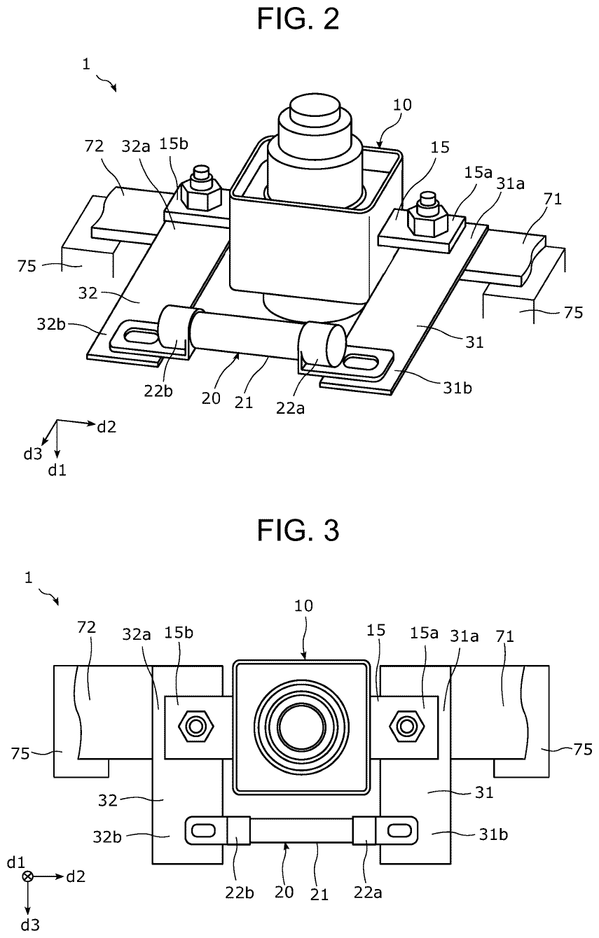

Next, a configuration of shutdown device 1 according to the exemplary embodiment will be described with reference to FIG. 2 to 6.

FIG. 2 is a perspective view of shutdown device 1 according to the exemplary embodiment. FIG. 3 is a top view of shutdown device 1.

Shutdown device 1 is a device that shuts down the supply of the power in power supply path PL. As illustrated in FIGS. 2 and 3, shutdown device 1 includes pyro-fuse 10 and melting fuse 20 connected in parallel to pyro-fuse 10. In addition, shutdown device 1 includes lead conductors 31 and 32 for connecting pyro-fuse 10 and melting fuse 20.

pyro-fuse 10 shuts down power supply path PL by dividing a bus bar of pyro-fuse 10 based on shutdown signal s1 output from abnormality detection device 60.

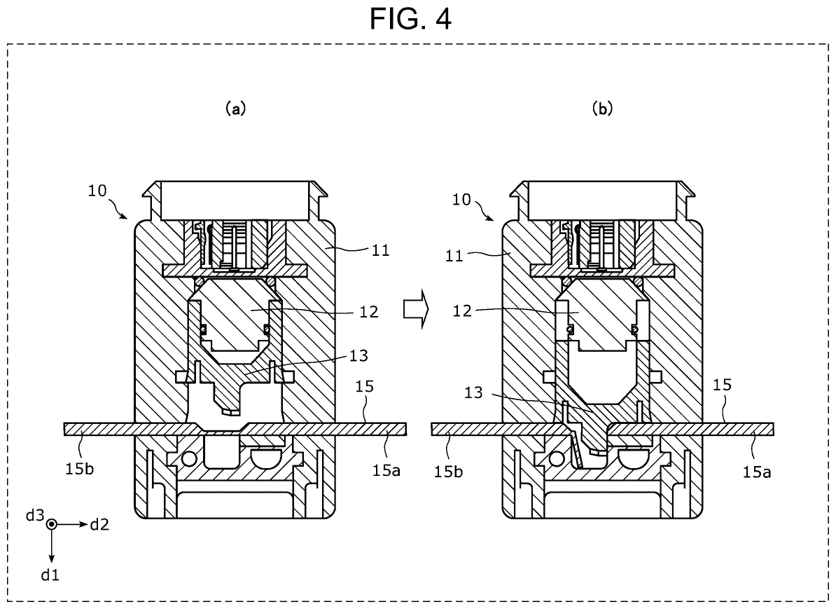

FIG. 4 is a sectional view illustrating pyro-fuse 10 included in shutdown device 1. (a) of FIG. 4 illustrates a state before bus bar 15 is divided, and (b) of FIG. 4 illustrates a state after bus bar 15 is divided. Note that, pyro-fuse 10 illustrated in FIG. 4 is merely an example, and a pyro-fuse having an appearance different from the appearance of FIGS. 2 and 3 is illustrated.

As illustrated in (a) of FIG. 4, pyro-fuse 10 includes casing 11 forming an outline of pyro-fuse 10, piston 13 movable in first direction d1, ignition unit 12 that activates piston 13, and bus bar 15 inserted into power supply path PL.

Casing 11 has a tubular shape and is disposed along first direction d1. A central portion of bus bar 15, piston 13, and ignition unit 12 are disposed inside casing 11. Both end portions of bus bar 15 are disposed outside casing 11.

Bus bar 15 is a linear and flat conductor, and is disposed along second direction d2 intersecting first direction d1. In this example, second direction d2 is a direction perpendicular to first direction d1. That is, in the present disclosure, first direction d1 is a downward direction, second direction d2 is a rightward direction, and third direction d3 is a backward direction. Bus bar 15 extending in second direction d2 penetrates a side surface of casing 11, and both end portions of bus bar 15 protrude outward from the side surface of casing 11.

As illustrated in FIGS. 2 and 3, bus bar 15 is inserted into power supply path PL by being connected to conductor plates 71 and 72 which are a part of power supply path PL. Specifically, one end portion 15a of bus bar 15 is connected to conductor plate 71 laterally protruding from insulating base 75 by a fastening member, and other end portion 15b of bus bar 15 is connected to conductor plate 72 laterally protruding from insulating base 75 by a fastening member. A bottom surface of pyro-fuse 10 is not supported by another member and floats in the air.

As illustrated in (a) of FIG. 4, ignition unit 12 is provided inside casing 11. Ignition unit 12 activates piston 13 in a case where an overcurrent is generated in power supply path PL, that is, in a case where shutdown signal s1 output from abnormality detection device 60 is received. Specifically, ignition unit 12 moves piston 13 at a high speed in first direction d1 by igniting gunpowder to rapidly expand a gas in casing 11. That is, piston 13 moves downward. In still other words, piston 13 moves toward bus bar 15.

Piston 13 has a cylindrical shape and is disposed inside casing 11 along first direction d1. Piston 13 moves in first direction d1 by ignition of ignition unit 12, and divides bus bar 15 (see (b) of FIG. 4). In addition, when bus bar 15 is divided, piston 13 collides with a part of bus bar 15 or casing 11, and generates vibration in first direction d1. The vibration generated by piston 13 is transmitted to melting fuse 20 via both end portions of bus bar 15 and lead conductors 31 and 32. The transmission of this vibration will be described later.

For example, when bus bar 15 is divided in a state where an overcurrent flows, there is a problem that an arc is generated in a divided region of bus bar 15. Therefore, in shutdown device 1, melting fuse 20 is connected in parallel to bus bar 15, and a current that continues to flow in the divided region of bus bar 15 flows into melting fuse 20 to suppress the generation of the arc in the divided region.

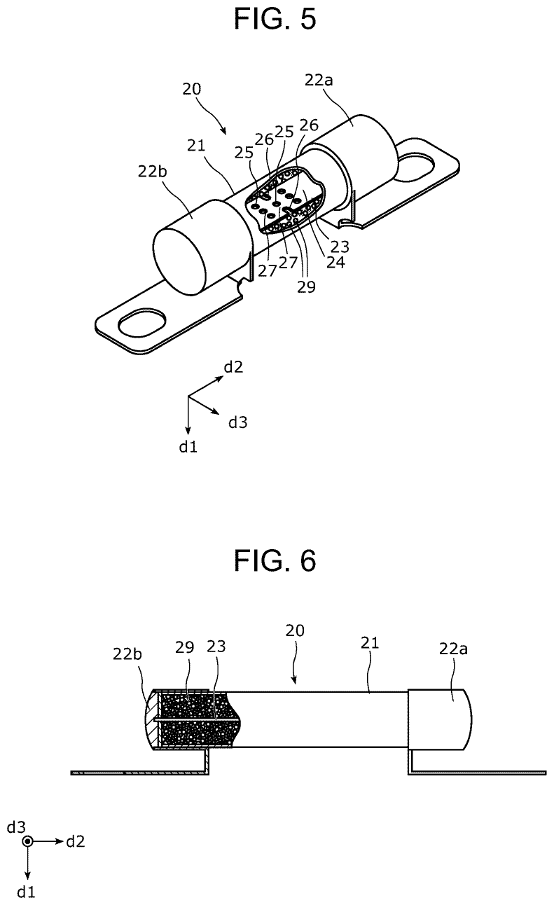

FIG. 5 is a perspective view of melting fuse 20 included in shutdown device 1. FIG. 6 is a sectional view of melting fuse 20. Note that, a part of FIG. 5 illustrates a state where fuse case 21 and arc-extinguishing material 29 are partially removed.

Melting fuse 20 is a fuse that shuts down power supply path PL by fusing in a case where an overcurrent flows. A resistance value of melting fuse 20 is more than or equal to 10 times of a resistance value of pyro-fuse 10. Thus, melting fuse 20 is configured to normally supply power via pyro-fuse 10 when the overcurrent is not generated. Note that, melting fuse 20 may be designed not to be fused in a case where a large current flows in a very short time. In addition, the resistance value of melting fuse 20 is preferably, for example, from 10 times to 100 times inclusive of the resistance value of pyro-fuse 10.

As illustrated in FIGS. 5 and 6, melting fuse 20 includes fuse case 21 that forms an outline of melting fuse 20, one terminal 22a and other terminal 22b that are external terminals, fuse element 23 that melts when the overcurrent flows, and arc-extinguishing material 29 in a granular phase.

Fuse case 21 is, for example, an insulating tube made of glass, ceramics, or resin, and fuse element 23 and arc-extinguishing material 29 are provided inside fuse case 21.

One terminal 22a and other terminal 22b are provided at both ends of fuse case 21, respectively. Fuse element 23 is disposed between one terminal 22a and other terminal 22b.

Fuse element 23 is a plate-shaped member that melts when the overcurrent flows. A material of fuse element 23 is, for example, aluminum or copper. One end of fuse element 23 is connected to one terminal 22a, and other end of fuse element 23 is connected to other terminal 22b. Fuse element 23 is disposed to extend along second direction d2. In addition, fuse element 23 has fuse element surface 24 having surfaces along second direction d2 and third direction d3, and is disposed such that fuse element surface 24 is perpendicular to first direction d1. Note that, fuse element surface 24 is an upper surface of fuse element 23. In addition, the perpendicular in the present exemplary embodiment is not limited to 90°, and includes, for example, a range within ±10°with respect to 90°.

Fuse element 23 includes a plurality of through-holes 25 arranged along third direction d3 perpendicular to both first direction d1 and second direction d2, a plurality of elongated holes 26 formed along third direction d3, and narrow portion 27 which is fused when the overcurrent flows. Narrow portion 27 is positioned between two through-holes 25 adjacent in third direction d3 or between through-hole 25 and elongated hole 26. Narrow portion 27 is a portion having a narrowest width (length in third direction d3) in fuse element 23, and is a portion to be fused when the overcurrent flows. The arc is generated in a fused region immediately after narrow portion 27 is melted.

Arc-extinguishing material 29 is a sandy material for extinguishing an arc generated when fuse element 23 is fused. Arc-extinguishing material 29 is made of spherical silica (silicon dioxide) or the like. A particle size of arc-extinguishing material 29 is, for example, less than or equal to 250 μm, and a ratio of a long radius to a short radius is less than or equal to 2.

Arc-extinguishing material 29 is disposed around fuse element 23 and is provided to be movable in fuse case 21 in first direction d1. That is, although fuse case 21 is filled with arc-extinguishing material 29, arc-extinguishing material 29 is melted when the arc is generated, a volume after melting becomes smaller than a bulk volume in a granular phase before melting, and a space is generated in a part of a periphery where arc-extinguishing material 29 is melted. At least a part of arc-extinguishing material 29 has a particle size smaller than a diameter of through-hole 25 and a width of elongated hole 26 to such an extent that the particle can pass through through-hole 25 and elongated hole 26 by vibration. In other words, arc-extinguishing material 29 contains particles having a particle size smaller than the diameter of through-hole 25 and the width of elongated hole 26.

In addition, at least a part of arc-extinguishing material 29 has a particle size smaller than a width of narrow portion 27. In other words, arc-extinguishing material 29 contains particles having a particle size smaller than the width of narrow portion 27.

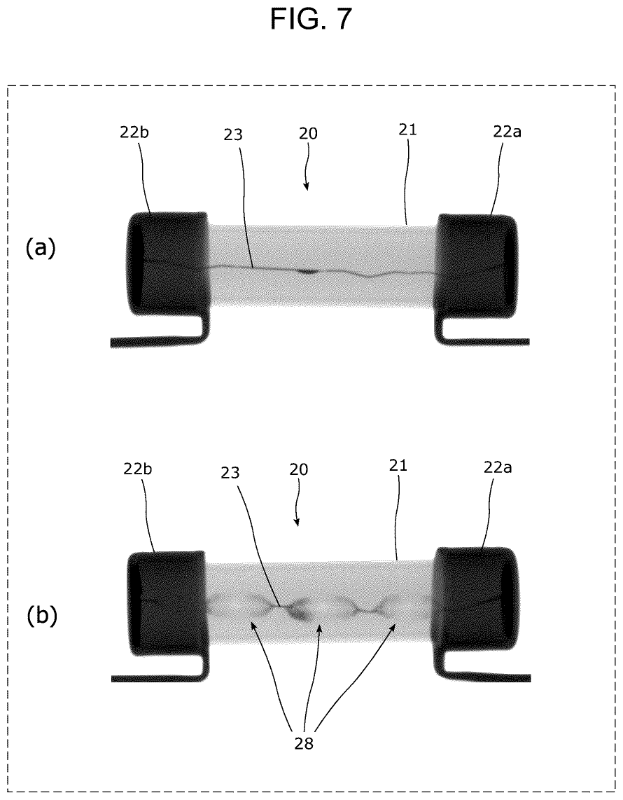

Here, states of melting fuse 20 before and after melting included in shutdown device 1 will be described with reference to FIG. 7. (a) of FIG. 7 illustrates the state before melting, and (b) of FIG. 7 illustrates the state after melting. As illustrated in (b) of FIG. 7, after melting, fuse element 23 is fused, and molten region 28 in which arc-extinguishing material 29 is remarkably melted by the arc is generated. Molten region 28 is a region where fuse element 23 around a portion to be fused evaporates and mixes with a portion to be fused in arc-extinguishing material 29.

Referring back to FIGS. 5 and 6, since arc-extinguishing material 29 in contact with the arc is melted, it is necessary to bring fresh arc-extinguishing material 29 that is not melted into contact with the arc in order to extinguish the arc in a short time. In order to extinguish the arc generated by the fusion of fuse element 23 in a short time, shutdown device 1 according to the exemplary embodiment has a structure in which melting fuse 20 is vibrated to bring fresh arc-extinguishing material 29 into contact with the arc. Hereinafter, a connection structure of pyro-fuse 10 and melting fuse 20 will be described.

As illustrated in FIGS. 2 and 3, melting fuse 20 is connected to pyro-fuse 10 via lead conductor 31 and lead conductor 32.

Each of lead conductors 31 and 32 is a linear and flat conductor. Each of lead conductors 31 and 32 is disposed along third direction d3 and is attached perpendicularly to bus bar 15. Note that, each of lead conductors 31 and 32 is not limited to a linear shape, and may have an L-shape or a U-shape.

One end of each of lead conductors 31 and 32 is fixed to conductor plates 71 and 72 by a fastening member or the like together with bus bar 15. Specifically, one end 31a of lead conductor 31 is connected to one end portion 15a of bus bar 15. One end 32a of lead conductor 32 is connected to other end portion 15b of bus bar 15.

The other ends of lead conductors 31 and 32 are respectively connected to external terminals 22a and 22b at both ends of melting fuse 20 by welding, brazing, or fastening members. Specifically, other end 31b of lead conductor 31 is connected to one terminal 22a of melting fuse 20 and is a free end. Other end 32b of lead conductor 32 is connected to other terminal 22b of melting fuse 20 and is a free end. Here, the “free end” refers to an end portion that is not fixed to be freely vibrated. That is, melting fuse 20 floats in the air through lead conductors 31 and 32, and is supported by lead conductors 31 and 32 to freely vibrate in first direction d1.

As described above, piston 13 generates vibration in first direction d1 by collision when bus bar 15 is divided. In other words, piston 13 generates vertical vibration by the collision when bus bar 15 is divided. The vibration generated by piston 13 is transmitted to melting fuse 20 via both end portions of bus bar 15 and lead conductors 31 and 32. Melting fuse 20 vibrates, and movement of arc-extinguishing material 29 is activated in fuse case 21. As a result, an opportunity for arc-extinguishing material 29 to come into contact with the arc generated in the fused region can be increased, and the arc generated in the fused region can be eliminated in a short time. According to shutdown device 1, the arcs generated in pyro-fuse 10 and melting fuse 20 can be efficiently extinguished.

Here, the efficient extinguishment of the generated arcs has the following advantages. First, the arc extinguishment (current attenuation) can be made faster. Second, the current can be shut down even though arc-extinguishing material 29 around fuse element 23 is small (that is, even with a small fuse tube). Third, the arc can be extinguished even in a case where a short circuit condition is severe (for example, the current is large, the voltage is high, or the like).

Note that, in the present exemplary embodiment, the first to third advantages described above can be obtained in the following description that the arcs can be efficiently extinguished.

In addition, a period of vibration generated by piston 13 colliding with bus bar 15 desirably coincides with a vibration period of melting fuse 20 connected to pyro-fuse 10 via lead conductors 31 and 32. In other words, the vibration generated by piston 13 colliding with bus bar 15 desirably includes a resonance frequency of lead conductors 31 and 32 and melting fuse 20 when both end portions of bus bar 15 are fixed ends.

### Operation of Shutdown Device

An operation of shutdown device 1 when power supply path PL is shut down will be described.

When an abnormality such as overcurrent occurs in power supply path PL, shutdown signal s1 is output from abnormality detection device 60 to pyro-fuse 10. pyro-fuse 10 having received shutdown signal s1 actuates piston 13 by the ignition of ignition unit 12 to divide bus bar 15.

Although the arc is generated in the divided region due to the division of bus bar 15, in shutdown device 1, since melting fuse 20 is connected in parallel to bus bar 15, a current that continues to flow to pyro-fuse 10 side flows through melting fuse 20. As a result, the generation of the arc in pyro-fuse 10 can be suppressed.

In addition, in shutdown device 1, piston 13 collides with bus bar 15 and casing 11 by the activation of piston 13, and vibration is generated in pyro-fuse 10. The vibration generated in pyro-fuse 10 is transmitted to melting fuse 20 via bus bar 15 and lead conductors 31 and 32. Melting fuse 20 starts to vibrate, and thus, arc-extinguishing material 29 in fuse case 21 is shaken in first direction d1 and reciprocates in accordance with the vibration period.

In addition, fuse element 23 is fused by a current flowing to melting fuse 20 side, but melting fuse 20 vibrates before the fusion of fuse element 23 starts by the activation of piston 13, and vibrates after the melting of fuse element 23 ends. As a result, a probability that arc-extinguishing material 29 comes into contact with the arc generated in the fused region can be increased, and the arc can be extinguished in a short time. That is, according to shutdown device 1, not only the generation of the arc in pyro-fuse 10 can be controlled, but also the arc can be efficiently extinguished even in melting fuse 20 after the generation of the arc.

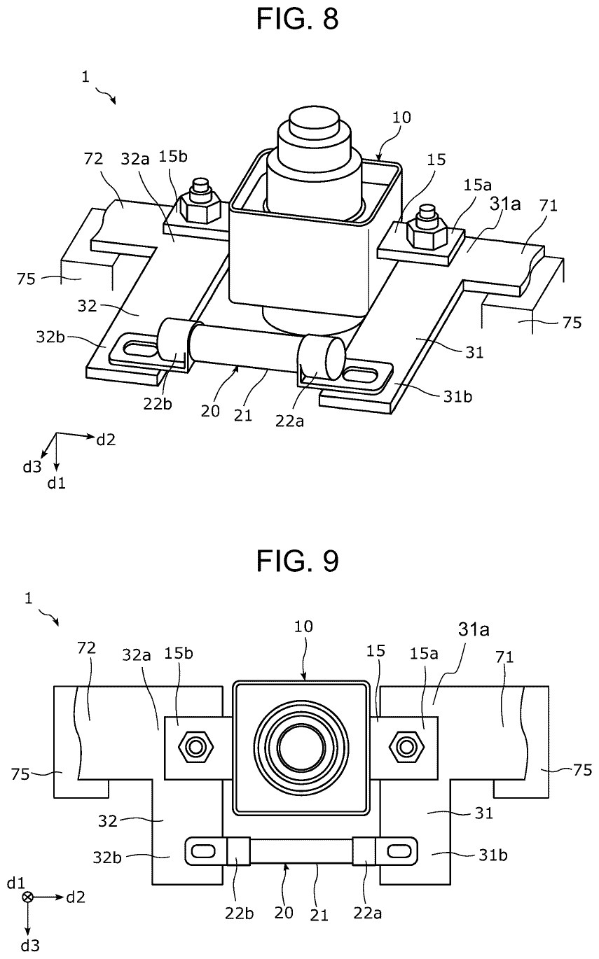

Note that, as illustrated in FIGS. 8 and 9, lead conductor 31 and conductor plate 71 may be integrally formed, and lead conductor 32 and conductor plate 72 may be integrally formed.

### CONCLUSION

Shutdown device 1 according to a first aspect is a shutdown device that shuts down power supply path PL. The shutdown device includes pyro-fuse 10 including bus bar 15 inserted into power supply path PL and piston 13 that is disposed above bus bar 15 and moves toward bus bar 15 to divide bus bar 15, and melting fuse 20 connected in parallel to pyro-fuse 10. Melting fuse 20 includes fuse case 21, fuse element 23 that is provided in fuse case 21 and is fused when an overcurrent flows, and arc-extinguishing material 29 that is provided in fuse case 21 and is in a granular phase, and fuse element 23 extends along a direction intersecting a direction (first direction d1) in which piston 13 moves.

According to this configuration, since melting fuse 20 is connected in parallel to pyro-fuse 10, the generation of the arc in pyro-fuse 10 can be suppressed. In addition, according to this configuration, since fuse element 23 extends along a direction intersecting the direction in which piston 13 moves, arc-extinguishing material 29 in fuse case 21 is easily moved by an operation of piston 13. Thus, the opportunity for arc-extinguishing material 29 to come into contact with the arc generated when fuse element 23 is fused can be increased. As a result, after the arc is generated in melting fuse 20, the arc can be efficiently extinguished.

In shutdown device 1 of a second aspect, fuse element 23 has a plate shape and extends along an extending direction of bus bar 15, and melting fuse 20 is disposed such that an upper surface of fuse element 23 is perpendicular to the direction in which piston 13 moves (first direction d1).

According to this configuration, arc-extinguishing material 29 moving in a same direction as the direction in which piston 13 moves (first direction d1) easily comes into contact with the fused region of fuse element 23. As a result, after the arc is generated in melting fuse 20, the arc can be efficiently extinguished.

In shutdown device 1 of a third aspect, fuse element 23 includes narrow portion 27 that is fused when the overcurrent flows, and arc-extinguishing material 29 contains particles having a particle size smaller than the width of narrow portion 27.

According to this configuration, arc-extinguishing material 29 easily comes into contact with the molten region formed by melting narrow portion 27. Thus, the opportunity for arc-extinguishing material 29 to come into contact with the arc generated in the molten region can be increased. As a result, after the arc is generated in melting fuse 20, the arc can be efficiently extinguished.

In shutdown device 1 of a fourth aspect, fuse element 23 has a plurality of holes (for example, through-hole 25 and elongated hole 26), narrow portion 27 is positioned between two adjacent holes among the plurality of holes, and arc-extinguishing material 29 contains particles having a particle size smaller than the plurality of holes (for example, through-hole 25 and elongated hole 26).

According to this configuration, since at least a part of arc-extinguishing material 29 can pass through through-hole 25 and elongated hole 26 by vibration, the opportunity for arc-extinguishing material 29 to come into contact with the arc generated in the molten region can be increased. As a result, the arc generated in melting fuse 20 can be efficiently extinguished.

In shutdown device 1 of a fifth aspect, the plurality of holes include through-hole 25 or elongated hole 26.

In shutdown device 1 of a sixth aspect, the arc-extinguishing material is disposed around fuse element 23, and is movable up and down in fuse case 21.

According to this configuration, the opportunity for arc-extinguishing material 29 to come into contact with the arc generated in the fused region of fuse element 23 can be increased. As a result, after the arc is generated in melting fuse 20, the arc can be efficiently extinguished.

In shutdown device 1 of a seventh aspect, melting fuse 20 is supported to be able to vibrate up and down.

According to this configuration, melting fuse 20 can be vibrated up and down along with the operation of piston 13. By this vibration, arc-extinguishing material 29 of melting fuse 20 can be frequently moved up and down, and the opportunity for arc-extinguishing material 29 to come into contact with the arc generated in the fused region of fuse element 23 can be increased. As a result, after the arc is generated in melting fuse 20, the arc can be efficiently extinguished.

In shutdown device 1 according to an eighth aspect, piston 13 collides with bus bar 15, and thus, melting fuse 20 starts to vibrate. As a result, melting fuse 20 vibrates even after fuse element 23 is fused.

According to this configuration, arc-extinguishing material 29 can be reliably brought into contact with the arc generated in the fused region of fuse element 23. As a result, after the arc is generated in melting fuse 20, the arc can be efficiently extinguished.

In shutdown device 1 of a ninth aspect, piston 13 collides with bus bar 15, and thus, melting fuse 20 vibrates before the fusion of fuse element 23 starts.

According to this configuration, arc-extinguishing material 29 can be reliably brought into contact with the arc generated in the fused region of fuse element 23. As a result, after the arc is generated in melting fuse 20, the arc can be efficiently extinguished.

Shutdown device 1 of a tenth aspect further includes lead conductor 31 (32) connecting bus bar 15 and melting fuse 20 each other, and lead conductor 31 (32) is connected to bus bar 15, other end 31b (32b) of lead conductor 31 (32) is a free end, and melting fuse 20 is supported by other end 31b (32b) of lead conductor 31 (32).

According to this configuration, melting fuse 20 can be vibrated via lead conductor 31 (32). Due to this vibration, arc-extinguishing material 29 of melting fuse 20 can be frequently moved, and the opportunity for arc-extinguishing material 29 to come into contact with the arc generated in the fused region of fuse element 23 can be increased. As a result, after the arc is generated in melting fuse 20, the arc can be efficiently extinguished.

In shutdown device 1 according to an eleventh aspect, the period of vibration generated by piston 13 colliding with bus bar 15 coincides with the vibration period of melting fuse 20.

According to this configuration, melting fuse 20 can be reliably vibrated. As a result, the opportunity for arc-extinguishing material 29 to come into contact with the arc generated in the fused region of fuse element 23 can be increased. As a result, after the arc is generated in melting fuse 20, the arc can be efficiently extinguished.

In shutdown device 1 of a twelfth aspect, the resistance value of melting fuse 20 is more than or equal to 10 times of the resistance value of pyro-fuse 10.

According to this configuration, when the overcurrent is not generated, power can be normally supplied via pyro-fuse 10. In addition, when the overcurrent is generated, power supply path PL can be shut down while the arc is efficiently extinguished after the arc is generated.

Shutdown system 50 according to a thirteenth aspect includes shutdown device 1 according to any one of the above aspects and abnormality detection device 60 that outputs shutdown signal s1 to pyro-fuse 10 in a case where the abnormality occurs in power supply path PL. pyro-fuse 10 of shutdown device 1 is ignited based on shutdown signal s1 output from abnormality detection device 60 to move piston 13 toward bus bar 15, and divides bus bar 15.

According to this configuration, it is possible to provide shutdown system 50 capable of shutting down power supply path PL while efficiently extinguishing the arc after the arc is generated.

### Other Exemplary Embodiments

Although the shutdown device and the shutdown system according to the exemplary embodiment of the present disclosure have been described above, the present disclosure is not limited to this exemplary embodiment. Configurations in which various variations conceived by those skilled in the art are applied to the present exemplary embodiments, and configurations established by combining components in different exemplary embodiments may also fall within the present disclosure, without departing from the gist of the present disclosure.

The shutdown device is mounted on, for example, a vehicle such as an automobile, an electrical appliance such as a home appliance, or the like. Examples of the vehicle include a vehicle including a battery such as a battery electric vehicle (BEV) vehicle and a plug-in hybrid vehicle (PHEV) vehicle. Note that, the shutdown device may be mounted on an object having an electric circuit other than the automobile and the electrical appliance. In addition, the shutdown device in the above-described exemplary embodiment and the like may be used, for example, for shutting down an overcurrent in a power storage system, a power transmission system, and the like.

### INDUSTRIAL APPLICABILITY

The present disclosure is useful for a shutdown device or the like that shuts down a power supply path when an overcurrent is generated.

### REFERENCE MARKS IN THE DRAWINGS

1: shutdown device

10: pyro-fuse

11: casing

12: ignition unit

13: piston

15: bus bar

15a: one end portion

15b: other end portion

20: melting fuse

21: fuse case

22a, 22b: terminal

23: fuse element

24: fuse element surface

25: through-hole

26: elongated hole

27: narrow portion

28: molten region

29: arc-extinguishing material

31, 32: lead conductor

31a, 32a: one end

31b, 32b: other end (first end)

50: shutdown system

60: abnormality detection device

61: detection unit

62: abnormality determination unit

71, 72: conductor plate

75: insulating base

BT: battery

d1: first direction

d2: second direction

d3: third direction

LD: load

PL: power supply path

s1: shutdown signal

sL: signal line

1. A shutdown device that shuts down a power supply path, the shutdown device comprising:
a pyro-fuse that includes
a bus bar inserted into the power supply path and
a piston disposed above the bus bar, the piston moving toward the bus bar to divide the bus bar; and
a melting fuse connected in parallel to the pyro-fuse, wherein
the melting fuse includes
a fuse case,
a fuse element provided in the fuse case and is fused when an overcurrent flows, and
an arc-extinguishing material provided in the fuse case and being in a granular phase, and
the fuse element extends along a direction intersecting a direction in which the piston moves.

2. The shutdown device according to claim 1, wherein
the fuse element has a plate shape and extends along an extending direction of the bus bar, and
the melting fuse is disposed such that an upper surface of the fuse element is perpendicular to the direction in which the piston moves.

3. The shutdown device according to claim 1 or 2, wherein
the fuse element has a narrow portion that is fused when the overcurrent flows, and
the arc-extinguishing material contains particles having a particle size smaller than a width of the narrow portion.

4. The shutdown device according to claim 3, wherein
the fuse element has a plurality of holes,
the narrow portion is positioned between two adjacent holes among the plurality of holes, and
the arc-extinguishing material contains particles having a particle size smaller than the plurality of holes.

5. The shutdown device according to claim 4, wherein the plurality of holes include a through-hole or an elongated hole.

6. The shutdown device according to claims 1 to 5, wherein the arc-extinguishing material is disposed around the fuse element, and moves up and down in the fuse case.

7. The shutdown device according to any one of claims 1 to 6, wherein the melting fuse is supported to vibrate up and down.

8. The shutdown device according to any one of claims 1 to 7, wherein
the melting fuse starts to vibrate by the piston colliding with the bus bar, and
the melting fuse vibrates even after the fuse element is fused.

9. The shutdown device according to any one of claims 1 to 8, wherein the melting fuse vibrates before the fusion of the fuse element starts by the piston colliding with the bus bar.

10. The shutdown device according to any one of claims 1 to 9, further comprising:
a lead conductor connecting the bus bar and the melting fuse each other, wherein
the lead conductor is connected to the bus bar,
a first end of the lead conductor is a free end, and
the melting fuse is supported at the first end of the lead conductor.

11. The shutdown device according to claim 10, wherein a period of vibration generated by the piston colliding with the bus bar coincides with a vibration period of the melting fuse.

12. The shutdown device according to any one of claims 1 to 11, wherein a resistance value of the melting fuse is more than or equal to 10 times of a resistance value of the pyro-fuse.

13. A shutdown system comprising:
the shutdown device according to any one of claims 1 to 12; and
an abnormality detection device that outputs a shutdown signal to the pyro-fuse in a case where an abnormality occurs in the power supply path, wherein
the pyro-fuse of the shutdown device is ignited based on the shutdown signal output from the abnormality detection device to move the piston toward the bus bar, and divides the bus bar.
